(19) United States
(12) Patent Application Publication
(10) Pub. No.: US 2016/0371306 A1
(43) Pub. Date: Dec. 22, 2016

(54) APPARATUS FOR A LUGGAGE CONVEYING DEVICE, AND METHOD FOR OPERATING A LUGGAGE CONVEYING DEVICE

(71) Applicant: SIEMENS AKTIENGESELLSCHAFT, München (DE)

(72) Inventor: ULRICH DENGLER, KONSTANZ (DE)

(73) Assignee: SIEMENS AKTIENGESELLSCHAFT, MUECHEN (DE)

(21) Appl. No.: 15/121,464

(22) PCT Filed: Feb. 24, 2015
(86) PCT No.: PCT/EP2015/053767

§ 371 Date: Aug. 25, 2016

(30) Foreign Application Priority Data
Feb. 27, 2014 (DE) 10 2014 203 591.0

(51) Int. Cl. G06F 17/30; G06K 9/62; B64F 1/36; H04N 7/18

(52) U.S. Cl. CPC G06F 17/30268; G06F 17/30259; G06F 17/3028; H04N 7/183; G06K 9/6202; B64F 1/368

(57) ABSTRACT

An apparatus and a method for a luggage conveying device. The apparatus has an image capturing device for taking at least one image of pieces of luggage that are to be conveyed, a database in which the image or data that is generated from the image and is specific to the piece of luggage can be stored at least in part, and an output device for outputting the stored image or the stored data on a piece of luggage that is to be identified.

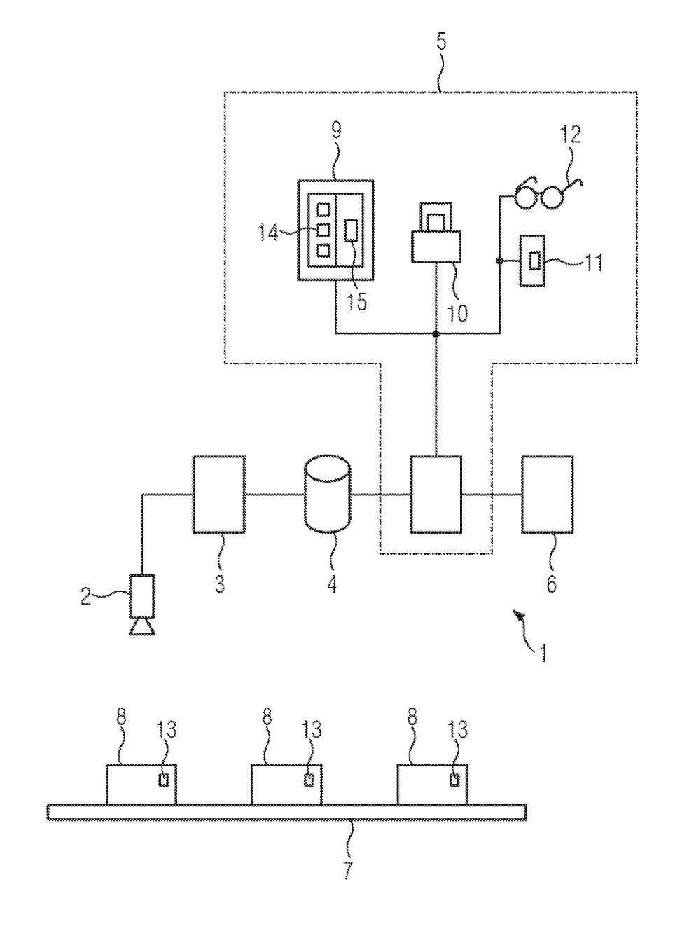

Apparatus for a luggage conveying device and method for operating a luggage conveying device

The invention relates to an apparatus for a luggage conveying device and a method for operating a luggage conveying device.

Luggage conveying devices are used to transport pieces of luggage at airports, for example suitcases or bags. The pieces of luggage are checked in by their owner or the passenger and are conveyed to the aircraft separately from the passenger and are handed back to the passenger at the destination. Problems arise in this respect with misdirected and lost pieces of luggage that do not arrive at the destination together with the passenger and hence have to be located and identified. In air transport for example very many pieces of luggage are misdirected annually. If a piece of luggage does not arrive at its predestined destination, this is initially determined by the passenger and then reported to the airline or the operator of the destination airport. In his report the passenger describes the piece of luggage in general terms, such as for example suitcase, bag, etc. This information about the lost piece of luggage is used to look for the piece of luggage based on the rough description and, where still available, to identify it with the help of the baggage tag. The baggage tag is an identification label that is attached to the piece of luggage when the passenger checks the piece of luggage in.

The object of the invention is hence to provide an apparatus for a luggage conveying device and a method for operating a luggage conveying device, by means of which misdirected and lost pieces of luggage can be more easily found again.

This object is inventively achieved by an apparatus for a luggage conveying device, having an image capturing device for taking at least one image of pieces of luggage that are to be conveyed, having a database in which the image or data generated from the image and specific to the relevant piece of luggage can be stored at least in part, and having an output device for outputting the stored image or the stored data on a piece of luggage that is to be identified.

The object is further achieved by a method for operating a luggage conveying device, in which at least one image is taken of pieces of luggage that are to be conveyed, in which the image or data generated from the image and specific to the respective piece of luggage is stored at least in part and in which for the subsequent identification of one of the pieces of luggage the stored image or the stored data on the pieces of luggage to be identified is output.

The advantage of the inventive solution is that the search for the piece of luggage is made easier and quicker with the help of the captured and outputtable information. Thus the piece of luggage can be identified more easily and quickly among a quantity of pieces of luggage. Even a piece of luggage that has had to be offloaded from the aircraft again, for example because its owner is not on board, can be identified more quickly thanks to the inventive solution.

The invention can be developed by advantageous embodiments which are described below. The advantageous embodiments can be combined at will.

Thus the output device can be designed for the pictorial output of the image or the data. The advantage of this is that a person who is looking for the piece of luggage can easily look at and view an image of it. For this the output device can for example comprise a printer or a monitor. In a particularly advantageous embodiment the output device can also comprise a handheld, a headup display or a smartphone. These in particular have the advantage that they are mobile, can easily be carried by a person and have displays which for example can be viewed in the cargo hold of an aircraft.

The apparatus can further comprise a data processing device which is designed to assign an identification code to the pieces of luggage and to link the image or the data to the identification code. The advantage of this is that the identification code, which may for example be a barcode on a baggage tag, can be used for finding and outputting the image. Thus for example with the help of the baggage tag, which for example was checked in by the passenger or which was found in some other way, the image of the associated piece of luggage can be retrieved. To retrieve the image on the basis of further data which is specific to the passenger, the database can additionally be designed to store the name of the owner, a flight number, a flight date and/or a flight time for the pieces of luggage.

To make it even easier to find lost pieces of luggage the apparatus can have a comparison device which is designed to compare images or data on pieces of luggage, among which the piece of luggage to be identified may be located, with the image or the data on the piece of luggage to be identified. The comparison device may for example have a monitor on which the image of the lost piece of luggage is displayed, along with the images of pieces of luggage that have been found and among which the lost piece of luggage may be located. The comparison device may further also be designed for the automated comparison of the image or the data on the piece of luggage to be identified with images or image data on pieces of luggage among which the piece of luggage to be identified may be located. Thus for example from the images of the pieces of luggage predetermined feature parameters may be determined and stored in a feature data set. The feature data sets of different pieces of luggage can then be compared automatically by the comparison device, and the images of potentially matching data sets can be displayed to an operator.

To integrate the apparatus particularly well into the luggage conveying device the image capturing device can be arranged such that the images can be taken during the automatic conveyance of the pieces of luggage in the luggage conveying device.

In an advantageous development of the inventive method the pieces of luggage can be assigned an identification code and the respective image or data can be linked to the identification code. This has the advantage that the image can be output on the basis of the identification code, which for example is a barcode on the baggage tag of the piece of luggage. The name of the owner, the flight number, a flight date and/or a flight time for the pieces of luggage can further be stored. This likewise makes it easier to find the right data set, including the image, for a lost piece of luggage.

In order to also display the image of the lost item remotely from the luggage conveying device, the image or the data on the piece of luggage to be identified can be output on a handheld device, headup display or smartphone.

To further simplify the identification of a lost piece of luggage, other images of pieces of luggage, among which the piece of luggage to be identified may be located, can be output simultaneously with the image of the piece of luggage to be identified for comparison. This can also be performed automatically.

In order to configure the inventive method so as to be integrated particularly well into the luggage conveying system, some of the images can be taken during the automatic conveyance of the pieces of luggage.

The invention is explained below on the basis of the exemplary embodiment in the attached drawing.

The FIGURE shows a schematic illustration of an exemplary embodiment of the inventive apparatus.

The FIGURE shows an inventive apparatus 1 which comprises an image capturing device 2, a data processing device 3, a database 4, an output device 5 and a comparison device 6. The FIGURE further shows a luggage conveying device 7 on which pieces of luggage 8 are conveyed.

The luggage conveying device 7, which is merely illustrated schematically in the FIGURE, is a luggage conveying device 7 which conveys pieces of luggage 8 for example at an airport and for this purpose comprises conveying systems, sorting devices and the like. In a known manner the pieces of luggage 8 are checked in at an appropriate desk, e.g. a check-in or baggage drop-off, are given a baggage tag 9 and are conveyed to the assigned aircraft. The image capturing device 2 is arranged such that the images can be taken during the automatic conveyance of the pieces of luggage 8 on the luggage conveying device 7.

The inventive apparatus 1 can be part of the luggage conveying device 7.

In the case of the exemplary embodiment in the FIGURE the image capturing device 2 is arranged above the luggage conveying device 7 and the pieces of luggage 8. The image capturing device 2 is for example a digital camera and is designed to take images of the pieces of luggage. The image capturing device 2 is arranged in respect of the luggage conveying device 7 such that the images are created in a suitable manner, so that color, size, shape, manufacturer and similar features central to identification can be identified on the image. Obviously the image capturing device may comprise multiple cameras and/or other image capturing devices. Furthermore, the image capturing device 2 is connected in terms of signaling to the data processing device 3.

The data processing device 3 for example comprises a computer system and is in turn connected to the database 4 in terms of signaling. The image capturing device 2, the data processing device 3, the database 4, the output device 5 and the comparison device 6 are each connected to one another in terms of signaling, for example via a computer network.

In the exemplary embodiment in the FIGURE the output device 5 comprises a monitor 9, a printer 10, a handheld or smartphone 11 and data goggles 12 with a headup display.

The use of the inventive apparatus 1 and the inventive method are described below.

Initially the image capturing device 2 takes at least one image of each piece of luggage 8 to be conveyed which moves past the image capturing device 2 on the luggage conveying device 7. The image is taken such that characteristic features of the respective piece of luggage 8 can be identified, such as color, size, labels, etc. To keep the data volume per image low, reduced image data can be generated from the image, which is specific to the piece of luggage and/or from which an image can be reconstructed again. The image or the data is output by the image capturing device 2 and is stored by the data processing device 3 in the database 4. To this end the data processing device 3 stores the image or the data such that it is linked to an identification code on the baggage tag 13. The data processing device 3 creates a data set in the database 4 for each piece of luggage 8, which comprises the image or the data generated from the image, the identification code, the name of the passenger or owner of the piece of luggage 8, the flight number, the flight date and/or the flight time. The data processing device 3 assigns each piece of luggage 8 the identification code in the data set, for example at the check-in of the luggage conveying device 7, which is also printed on the baggage tag 13 in the form of a barcode.

When subsequently one of the pieces of luggage 8 does not arrive at the destination with the passenger, the passenger initiates a search request, by means of which the lost piece of luggage 8 is searched for. The search order is assigned the images or data on the piece of luggage stored in the database 4, from which an image can be reconstructed. For this the image or the data is output by the output device 5. For example, an image of the piece of luggage to be identified is printed out on the printer 10 or displayed on the monitor 9, the data goggles 12 or the smartphone/handheld 11. The person or persons conducting the search can therefore, on the basis of the image of the piece of luggage 8 output by the output device 5, search in a quantity of pieces of luggage 8 left behind at the airport, for example. Alternatively a piece of luggage 8 that has to be offloaded again before departure of the aircraft because the passenger is not on board the aircraft can be found in this way particularly quickly in the cargo hold of an aircraft. Thanks to the invention this can be done at the airport particularly quickly and thus particularly advantageously for the airline.

To accelerate the identification of the piece of luggage 8 to be searched for, the inventive comparison device 6 can also be used. For this, remaining pieces of luggage 8 and other found pieces of luggage 8 are photographed and images thereby generated, for example at a baggage carousel of the luggage conveying device 7. These images 14 of the pieces of luggage 8, among which the piece of luggage 8 to be identified may be located, are output on the monitor 9 by the comparison device 6 simultaneously with the image 15 of the piece of luggage to be identified 8. The advantage of this is that the person in charge of the search can perform the search easily and quickly on the monitor.

In a further embodiment the comparison device 6 can also compare the data on the lost piece of luggage 8 automatically with the data on other pieces of luggage 8 among which the lost piece of luggage 8 may be located. To this end the image of each piece of luggage 8 is analyzed by the data processing device 3 such that predetermined feature parameters, such as for example color, size or shape, are evaluated and saved. These predetermined feature parameters of the pieces of luggage 8 are then automatically compared to each other by the comparison device 6. Hits or possible hits can be output to the person in charge of the search by the output device 5 for verification. The comparison device 6 can be designed to be integrated into a computer system.

The owner of the piece of luggage 8 can identify his piece of luggage 8 on the basis of the image both when issuing the search order and after the piece of luggage is found. As a result the quality of the search can be further improved.

1-15. (canceled)

16. . An apparatus for a luggage conveying device, the apparatus comprising:
an image capturing device for taking at least one image of a piece of luggage to be conveyed;
a database configured to store, at least in part, the image or data generated from the image and specific to the respective piece of luggage; and
an output device configured to output the stored image or the stored data on a piece of luggage to be identified.

17. The apparatus according to claim 16, wherein said output device is configured for a pictorial output of the image or data.

18. The apparatus according to claim 16, wherein said output device is selected from the group consisting of a handheld, a head-up display and a smartphone.

19. . The apparatus according to claim 16, which comprises a data processing device configured to assign an identification code to the pieces of luggage and to link the image or data to the identification code.

20. The apparatus according to claim 16, wherein said database is configured to store one or more of a name of an owner of the piece of luggage, a flight number, a flight date, or a flight time for the piece of luggage.

21. The apparatus according to claim 16, which comprises a comparison device configured to compare images or data on pieces of luggage, among which the piece of luggage to be identified may be located, to the image or data on the piece of luggage to be identified.

22. The apparatus according to claim 21, wherein said comparison device is configured to automatically compare the image or data on the piece of luggage to be identified to images or image data on pieces of luggage among which the piece of luggage to be identified may be located.

23. The apparatus according to claim 16, wherein said image capturing device is disposed to acquire the image during an automatic conveyance of the piece of luggage in the luggage conveying device.

24. A method for operating a luggage conveying device conveying pieces of luggage, the method comprising:
taking at least one image of a piece of luggage to be conveyed;
saving, at least in part, the image or data generated from the image and specific to the respective piece of luggage;
outputting the stored image or the stored data on the piece of luggage to be identified for a subsequent identification of one of the pieces of luggage.

25. The method according to claim 24, which comprises assigning the pieces of luggage an identification code and linking the respective image or the respective data to the identification code.

26. The method according to claim 24, which comprises storing a name of an owner, the flight number, a flight date and/or a flight time for the pieces of luggage.

27. The method according to claim 24, which comprises outputting the image or the data on the piece of luggage to be identified on a handheld device, head-up display or a smartphone.

28. The method according to claim 24, which comprises outputting, for comparison, images of pieces of luggage among which the piece of luggage to be identified may be located, simultaneously with the image of the piece of luggage to be identified.

29. The method according to claim 24, which comprises comparing the image or the data on the piece of luggage to be identified in an automated process with other images or image data on pieces of luggage among which the piece of luggage to be identified may be located.

30. The method according to claim 24, which comprises acquiring at least some of the images during an automatic conveyance of the pieces of luggage.
